(19) United States
(12) Patent Application Publication
(10) Pub. No.: US 2012/0138733 A1
(43) Pub. Date: Jun. 7, 2012

(54) High-Altitude Aerial Vehicle

(75) Inventors: Manfred Hiebl, Sauerlach (DE); Hans-Wolfgang Pongratz, Taufkirchen (DE)

(73) Assignee: EADS Deutschland GmbH, Ottobrunn (DE)

(21) Appl. No.: 13/310,125

(22) Filed: Dec. 2, 2011

(30) Foreign Application Priority Data
Dec. 3, 2010 (DE) 10 2010 053 372.6

(51) Int. Cl. B64B 1/02; B64B 1/40

(52) U.S. Cl. 244/30; 244/31

(57) ABSTRACT

A high-altitude aerial vehicle, in particular an aerial vehicle for the stratosphere that is designed as a non-rigid aerial vehicle with a hull, that has an at least partially inflated envelope with a buoyant gas other than air, which is lighter than air, in particular hydrogen. The hull is provided with at least a first chamber for the buoyant gas and at least a second chamber that can be inflated with air. Between the first and second chambers a flexible partition wall is provided that is preferably formed by a flexible membrane. Inflating of the second chamber, preferably with hot air depending on the flight altitude, can be controlled or regulated in such a way that the envelope of hull is always tautly inflated.

### CROSS REFERENCE TO RELATED APPLICATIONS

The present application claims priority under 35 U.S.C. §119 to German Patent Application No. 10 2010 053 372.6, filed Dec. 3, 2010, the entire disclosure of which is herein expressly incorporated by reference.

### BACKGROUND AND SUMMARY OF THE INVENTION

The present invention relates to a high-altitude aerial vehicle, in particular an aerial vehicle for the stratosphere, which is designed as non-rigid airship.

An important objective for protecting a territory from enemy attacks consists of early identification of approaching missiles, for example, rockets, so that it is possible to detect these missiles at such an early point in time that they can be combated effectively. Monitoring airspace by using satellites is very expensive and complex. An observation platform that is positioned at high altitude, for example, in the stratosphere, could therefore be an alternative to satellites.

Even for other tasks that are usually performed by satellites, stratospheric platforms could be used, for example, as a relay station for wireless signal transmission, for example, to replace or complement communication satellites.

It is known to use unmanned aerial vehicles based on balloons that can attain comparable flight altitudes and have low operating costs. These balloon-based aerial vehicles, however, cannot be maneuvered to the required degree in terms of altitude, and also horizontally, and therefore, for example, cannot maintain a specified position due to winds prevailing at high altitudes. In particular, the jet stream prevailing at high altitudes, which has a path that is not constant, requires a suitable maneuverability of the high-altitude aerial vehicle, so that it can be positioned outside or at the edge of the jet stream, for example, in such a way that it is nearly stationary relative to a location on the surface of the earth.

Moreover, conventional aerial vehicles are known that have the required maneuverability, but with which only limited flight duration is possible and which thereby incur very high operating costs.

Exemplary embodiments of the present invention provide a high-altitude aerial vehicle, which can be positioned, preferably stationary above the earth in the upper stratosphere up to a height of approximately 38 km having nearly unlimited flight duration. An aerial vehicle of this type can carry corresponding cargo equipment as well as a propulsion control, flight regulation and communication equipment, and the energy supply that is required for such, and can be operated autonomously.

A high-altitude aerial vehicle of this type according to the invention that is particularly suitable as a stratospheric aerial vehicle is designed as non-rigid airship with a hull, which has an envelope at least partially inflated with a buoyant gas that is lighter than air. This buoyant gas is preferably hydrogen. According to the invention, the high-altitude aerial vehicle differentiates itself in that the hull is provided with at least a first chamber for the buoyant gas, the hull has at least a second chamber that can be inflated with air, between the first chamber and the second chamber a partition wall is provided that is preferably formed by a flexible membrane, and the inflating of the second chamber, preferably with hot air depending on the flying altitude, can be controlled or regulated in such a way that the envelope of the hull is always tautly inflated. For this purpose, the second chamber can be provided with a fill control device that can be controlled or regulated.

The design with two chambers or two groups of chambers, namely a first chamber for the buoyant gas and a second chamber for inflating with air has the advantage that the differences in pressure during the ascent from the earth up to the stratosphere that impinge upon the aerial vehicle can exclusively be compensated by the air provided in the second chamber or in the second group of chambers, by releasing air during the ascent from the second chamber to the environment, so that the buoyant gas contained in the first chamber can expand by deforming the flexible membrane within the envelope of the aerial vehicle without having to blow off the buoyant gas from the first chamber.

Moreover, this design makes the pressure compensation possible, which is required for vertical maneuverability of the high-altitude aerial vehicle during its operation. When the aerial vehicle must change its altitude, for example, when it must descend from a previously occupied altitude in order to avoid high-altitude wind, the aerial vehicle then moves into an altitude position above the earth in which higher exterior pressure prevails that impinges on the envelope. To maintain the exterior structural shape of the aerial vehicle even at this altitude with greater ambient pressure, the pressure in the interior of the envelope of the aerial vehicle must likewise be increased. This can, in turn, take place by blowing ambient air into the second chamber. The fill control device thus ensures that the exterior contour of the high-altitude aerial vehicle remains constant above the earth at every flight altitude, by controlling the pressure of the air in the second chamber without incurring any loss of the buoyant gas that is different from air in the first chamber.

It is particularly advantageous when the first chamber that can be inflated with buoyant gas other than air is provided in the upper part of the hull and when the second chamber that can be inflated with air is provided in the lower part of the hull.

Preferably, the partition wall is reflecting on its upper side, as a result of which the radiation of thermal energy into space is reduced.

On its underside, the partition wall is preferably infrared-absorbent so that infrared radiation emanating from the earth heats the buoyant air inflating in the lower chamber day and night considerably above the ambient temperature prevailing at the corresponding altitude. Thereby, additional static lift is created, without a need to consume any of the energy reserves of the aerial vehicle.

It is also advantageous when a fill control device is provided for the second chamber, which has at least one blow-off valve, so that a controlled escape of air from the second chamber is possible and when the fill control device has at least one ventilation air blower, so that air can be pumped from the environment into the second chamber. In this way, the fill control device can perform a controlled regulation of the air pressure prevailing in the second chamber and adapt this interior air pressure to the requirements at the corresponding flight altitude in such a way that the envelope of the aerial vehicle is always tautly inflated without collapsing, and also without being exposed to the danger of bursting, because of an interior overpressure.

The fill control device preferably has a solar heat exchanger that heats air flowing into the second chamber by impinging solar radiation. As a result, the ambient air introduced into the second chamber from the outside, which is significantly below 0° C. at high altitudes, can be preheated using solar heat, so that in this way, additional aerodynamic lift is created for the aerial vehicle.

It is also particularly advantageous when the fill control device is configured in such a way that air contained in the interior of the second chamber can be circulated through the solar heat exchanger in a flowing stream. This variant makes it possible to circulate the air already contained in the second chamber through the solar heat exchanger and to thereby increase the temperature of the air in the second chamber, which also leads to an increase in the lift of the aerial vehicle.

Preferably, underneath the hull, at least one pod is provided for housing cargo, which is connected with the hull by attachment elements. These attachment elements can, for example, be formed by tensioning ropes.

It is also particularly advantageous when the hull is provided with at least one airfoil generating aerodynamic lift. Such an airfoil on the aerial vehicle designed as non-rigid airship makes it possible to utilize, in addition to the aerostatic lift, an aerodynamic lift for controlling the vertical position of the aerial vehicle.

It is of particular advantage when the airfoil has an aerodynamically shaped envelope having a longitudinal cross section that consists of a thin film, preferably a polyester film or aramid film (for example KEVLAR® film), or an aramid fiber fabric, when the airfoil has at least one hose that can be inflated with pressurized gas in wingspan direction, that extends, in inflated condition, preferably together with a grid lattice carrier that is inscribed in the hose designed as a compression member and extends over the entire wingspan, forms a reinforcement of the airfoil against compressive forces in wingspan direction and when the free ends of the airfoil are tensioned against the hull and/or against a pod provided under the hull, are preferably tensioned with bracing units including tensioning ropes. A polyester film that is particularly suitable because of its stability is a biaxially oriented polyester film such as it is available in the market under the trade name Mylar®, for example.

This airfoil is marked by its extremely low weight, because it gets its stiffness in the wingspan direction exclusively from the hose inflated with pressurized gas or from several hoses that are inflated with pressurized gas. Thus, for example, several hoses inflated with pressurized gas can extend in the direction of the wingspan having different diameters and which are connected to each other and are surrounded by a joint outer envelope, so that a wing having a profile generating aerodynamic lift results from this structure. If pressurized gas is used as gas for filling the hoses that is lighter than air, for example, hydrogen or helium, the airfoil then has an aerostatic lift component, as well as an aerodynamic lift component in the event of corresponding incident flow.

The tensioning of the free ends of the airfoil against the hull and/or against a pod provided under the hull ensures that the airfoil does not bend upward under the load of the uplift forces impinging upon it. In addition to the tensioning ropes provided at the free ends of the airfoil, additional tensioning ropes can be fastened between the respective free end of the airfoil and its fastening at the hull, which then likewise are braced against the hull and/or against a pod provided under the hull.

If the high-altitude aerial vehicle is provided with at least one drive propulsion system having a propeller, the aerial vehicle is then also capable of independently performing a horizontal position change, independent of prevailing winds. Such a high-altitude aerial vehicle provided with a drive propulsion system can thus be maneuvered horizontally as well as vertically.

It is particularly advantageous when the drive propulsion system is located in a pod that is provided under the hull. This engine pod is also connected with the hull and if necessary with the cargo pod by attachment elements that can, for example, be tensioning ropes. This separate location of the drive propulsion system in an independent engine pod ensures that vibrations emanating from the drive propulsion system are not transmitted to the hull of the aerial vehicle and perhaps to the cargo pod so that, for example, instruments that are present in the cargo pod are not exposed to any vibrations emanating from the drive propulsion system.

An electric propulsion engine has shown to be particularly suitable. The propulsion energy for the electric propulsion engine, and also for other electrical systems of the aerial vehicle and its cargo preferably takes place via a photovoltaic solar energy supply unit that is provided with at least one photovoltaic solar generator that transforms impinging solar radiation into electric energy, and is connected with at least one hydrogen generator for generating hydrogen from water, at least one water reservoir that is connected with a hydrogen generator by a first water line, at least one hydrogen reservoir preferably formed by the first chamber that is connected by a first water line with the hydrogen generator, at least one fuel cell that is connected with the hydrogen reservoir via a second water line and which is connected with the water reservoir by a second water line and a control unit that is connected electrically with the solar generator, the hydrogen generator and the fuel cell. If the upper chamber is used as hydrogen reservoir, the hydrogen that is stored there simultaneously fulfills the task of the lifting gas and that of the fuel for the fuel cell.

The parallel provision of a photovoltaic solar generator, a hydrogen generator and a fuel cell in this energy supply system makes it possible during the day, when sufficient solar radiation is available, to use some of the electric energy generated by the solar generator for generating hydrogen from water which is then, when no solar radiation is available during the night, recombined with ambient oxygen into water in the fuel cell for generating electric energy by the fuel cell. In this way, electric energy is always available that is either directly supplied by the solar generator, or indirectly by the fuel cell. The sole input energy for this system is solar radiation, as water, hydrogen and oxygen form a cycle that has reservoirs for water and for hydrogen.

In a preferred refinement, the hydrogen generator has a water electrolysis device.

The solar generator has at least one carrier element that is provided with solar cells, which is formed by a panel.

Alternatively, the carrier element can be formed by a thin film, preferably a polyester film and further preferred, by a biaxially oriented polyester film. This structure ensures a very low weight of the carrier element, which especially then, when it is formed by a biaxially oriented polyester film, as is known, for example, under the trade name “MYLAR”, has a very high robustness at a low weight.

It is especially preferred when the solar cells are thin-layer solar cells, whereby these are preferably cadmium telluride cells. These types of thin-layer solar cells likewise have a very low weight, so that in connection with the carrier element formed by the thin film, a solar generator of very light weight is formed.

Preferably, the photovoltaic energy supply system is additionally provided with an electric energy storage that is designed, for example, as a battery. This electric energy storage forms a buffer storage that can supply electric energy for a short time, when the solar generator is not charged with sufficient solar radiation for a short period of time. This electric energy storage is therefore used to bridge the time that is needed for activating the fuel cell, or in the event the fuel cell is not activated, for bridging that time that must be bridged, for example when a brief shadow effect on the sunlight, until this sunlight again impinges on the solar generator.

The photovoltaic energy supply system is preferably provided with a control unit, which is equipped in such a way that when solar radiation is present, the electric energy generated by the solar generator is supplied to an electric user connection of the energy supply system, and that when no solar radiation is present, or when the electric energy generated by the solar generator is insufficient for a specified energy demand, activates the fuel cell in order to deliver electric energy to the user connection. This control unit thus ensures that the fuel cell is automatically activated when not enough or no solar radiation is available.

Especially preferred is a design of the control unit in such a way that it, in the presence of solar radiation, delivers some of the electric energy supplied by the solar generator to the hydrogen generator, and that it supplies water to the hydrogen generator from the water reservoir, so that the hydrogen generator is activated in order to generate hydrogen from the water that has been supplied to it, which is stored in the hydrogen reservoir. In this embodiment, some of the electric energy generated by the solar generator is always used for operating the hydrogen generator in order to generate hydrogen, which is needed by the fuel cell for generating electric energy when the solar generator delivers none or insufficient electric energy. Thereby, the control unit can control the amount of electric energy that is supplied to the hydrogen generator, or also the turn-on times of the hydrogen generator, depending on the available hydrogen supply.

It is also advantageous when some of the electric energy generated by the solar generator and/or by the fuel cell is delivered to the energy storage, in order to charge it. This ensures that electric energy is always buffered in the energy storage so that it can be used directly when needed.

Preferably, the solar generator is located in the interior of the envelope of the aerial vehicle that is transparent, at least in sections. In this way, the solar generator is provided within the aerodynamic shell of the aerial vehicle and does not represent any additional aerodynamic resistance. As a result of the transparent design in sections of the envelope, the solar radiation can impinge on the solar generator through the envelope.

It is especially advantageous when the solar generator is gimbal-mounted within the envelope of the aerial vehicle and is provided with a tracking unit that always aligns the solar generator to the sun. This variant allows, independent of the position and flight direction of the aerial vehicle, utilization of the impinging sunlight optimally for generating electric energy by using the solar generator.

If the aerial vehicle is provided with pitch or side rudders, which are preferably attached to the hull, the maneuverability of the aerial vehicle that is designed as non-rigid aerial vehicle is further improved. These pitch and/or side rudders can also be designed in the same way as the airfoil so that at the lowest possible weight, a particularly effective maneuverability of the aerial vehicle is achieved.

Preferred exemplary embodiments of the invention with additional design details and additional advantages are described and explained in the following in further detail by referring to the enclosed drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

Shown are:

FIG. 1 shows a schematic perspective illustration of an aerial vehicle according to the invention; and

FIG. 2 shows a schematic diagram of a photovoltaic energy supply system for the aerial vehicle according to the invention

### DETAILED DESCRIPTION OF THE DRAWINGS

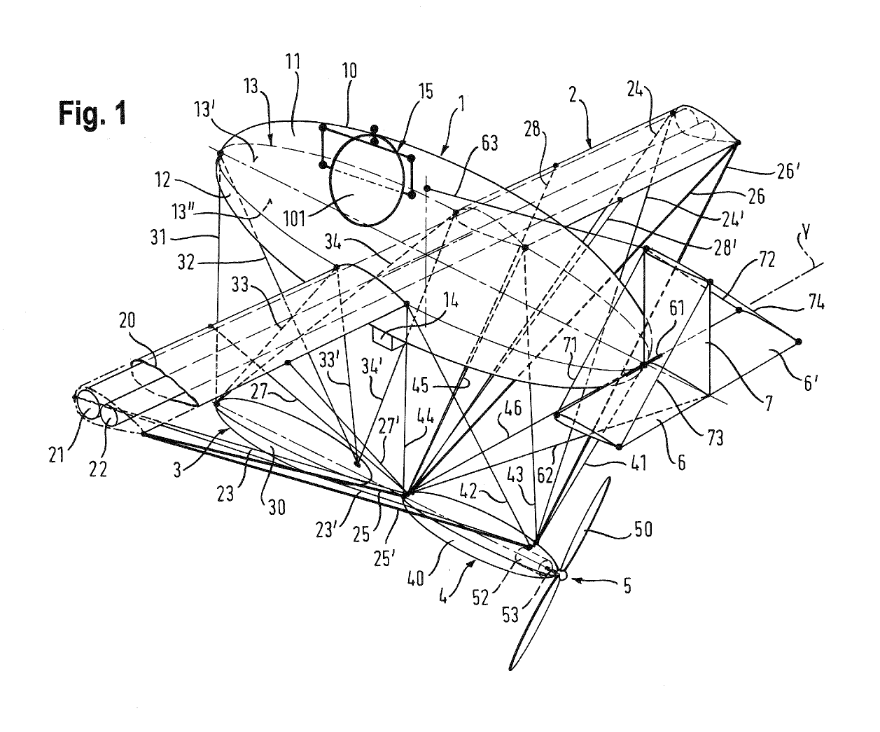

In FIG. 1, a high-altitude aerial vehicle, which is designed as non-rigid aerial vehicle according to the invention, is shown in perspective illustration. It has a hull 1, that is confined by an envelope 10 and which has an upper first chamber 11 and a lower second chamber 12 in the interior. Hull 1 has the shape of an ellipsoid, the length and diameter of which have a relationship of approximately 2, 5:1. This represents an optimal combination of a small surface area, large volume and low aerodynamic head resistance.

The first chamber 11 is inflated with a buoyant gas (hydrogen), which is lighter than air, and the second chamber 12 is inflated with air. A partition wall 13 formed by a flexible membrane is arranged between the first chamber 11 and the second chamber 12. The second chamber 12 is provided with a fill control device 14 (shown only symbolically in FIG. 1) that controls or regulates the inflation of second chamber 12 with air depending on the flight altitude in such a way that envelope 10 of hull 1 is always tautly inflated.

The air in second chamber 12 is preheated by the waste heat of the equipment on board of the aerial vehicle, and with solar heat, in order to achieve additional lift in this way. Fill control device 14 includes a blower, which continually feeds into second chamber 12 with slight overpressure, and thereby retains envelope 10 of hull 1 tautly and in its aerodynamically most favorable shape.

Inflating first chamber 11 with hydrogen as buoyant gas is calculated according to the invention in such a way that at the highest altitude service level of the aerial vehicle, envelope 10 is completely inflated with hydrogen. This highest altitude service level is, for example, 38 km. The volume of hull 1 that is enclosed by envelope 10 is calculated in such a way that the static lift of the hydrogen amounts to 50% to 60% of the weight of the aerial vehicle and that the remaining weight of the aerial vehicle is generated by dynamic lift. For this, the aerial vehicle is provided with an airfoil 2 that performs the required lift at sufficient flying speed. The volume of hull 1 enclosed by envelope 10 is, for example, 36,000 m³ at an aerial vehicle weight of 320 kg and a highest altitude service level of 38 km. The length of the envelope is then 76 m at a diameter of 30 m.

Airfoil 2 has an envelope 20 of a thin film that is formed aerodynamically in longitudinal cross section consisting of, for example, a biaxially oriented polyester film, as available in the market under the trade name “MYLAR®”. For example, this film has a thickness of 12 μm. To reinforce airfoil 2, it is provided in the interior in the wingspan direction extending over essentially the entire wingspan with an anterior, first hose 21 that forms the nose radius of the wing profile, and a posterior, second hose 22 that forms the largest profile thickness of preferably 18% at preferably 50% profile depth that are adapted in diameter to the aerodynamic shape of envelope 20, whereby the second, posterior hose 22 has a larger diameter of preferably 18% of the profile depth than the first, anterior hose 21. Second hose 22 has—just like first hose 21—likewise a—not shown—grid framework carrier in the interior extending over the entire wingspan. The two hoses 21, 22 have an outer skin that is likewise formed by a thin film, and are inflated with compressed gas, preferably with hydrogen. As a result of this inflating with pressurized gas, hoses 21, 22 are reinforced and in this way form a bearing reinforcement of airfoil 2 in the direction of the wingspan. Additionally, each one of the two hoses 21 and 22 is also provided with a very light grid pipe compression member carrier that is inscribed in it, which can respectively absorb compressive forces in wingspan direction and thereby additionally reinforces the airfoil against buckling, pressure, bending, tipping and torsion. Moreover, the two grid pipe compression member carriers among themselves are provided with triangular distance holders that reinforce the wing in flight direction. The wing profile is intended to preferably form a laminar profile with large nose radius at the position of first hose 21, and a profile thickness of preferably 18% at the position of second hose 22. The laminar profile shape must, if necessary, be molded with additional reinforcements (ribs). Hoses 21, 22 that are inflated with compressed gas and reinforced with carriers ensure not only a reinforcement of airfoil 2 against buckling, but also tense skin 20 of airfoil 2 and thus bring about the desired aerodynamic profile shaping of the wing. If required, additional rigid reinforcement elements can be provided in wingspan direction, as well as rectangular to it, i.e., in the longitudinal direction of the aerial vehicle.

A pod 3 for housing cargo is provided underneath hull 1 and is connected with hull 1 via carrier elements. Pod 3 has an aerodynamically shaped envelope 30 consisting of the same thin film as envelope 10 of hull 1, for reasons of weight. Envelope 30 is either retained by rigid structural elements or—just like hull 1—by being inflated with compressed air into its aerodynamic shape.

The carrier elements with which cargo pod 3 is suspended at hull 1 consist of an anterior tensioning rope 31, which extends between the anterior tip of pod 3 in flight direction, and the nose of hull 1. A further tensioning rope 32 extends from the nose of hull 1 to the tail of pod 3. Moreover, extending from the nose of pod 3 are also a left anterior tensioning rope 33 and a right anterior tensioning rope 34 to the respectively anterior end of the wing root, i.e. to an anterior point at which airfoil 2 transitions into hull 1. Moreover, a left, posterior tensioning rope 33′ and a right, posterior tensioning rope 34′ extend from the tail of pod 3 to the respective anterior end of the wing root.

In flight direction, behind cargo pod 3 a further pod is provided, namely an engine pod 4, the structure of which corresponds to cargo pod 3, and which has an outer envelope 40. Engine pod 4 houses a propulsion drive 5 for the aerial vehicle, that has a propeller 50 provided at the tail of engine pod 4, as well as a propulsion engine 52 that is provided in engine pod 4 that drives propeller 50 using known force transmission tools 53 (shaft, transmission). Preferably, the propulsion engine 52 is an electric motor.

To achieve a good degree of advancing drive effectiveness and thus low consumption of energy, propeller 50 has a large diameter and moves at low rpm. For example, at a flight weight of 320 kg and a highest altitude service level of 38 km, and a desired flying speed of 10 m/sec, the propeller can have a diameter of 15 m, to achieve a high degree of advancing drive effectiveness at low rpm. The use of such large propellers in light aerial vehicles is only possible without incurring undesirable vibrations, if this propeller has, just like a helicopter rotor blade, a continuous rotor blade that is mounted rocking at the shaft by using a flapping hinge, so that the propeller, when rotating at asymmetric flow, for example due to the influence of the hull, can perform a rocking motion. As a result of the joint, no moments can be transmitted to the shaft, which could cause the aerial vehicle to experience undesired vibrations that could be critical, especially for the operation of sensors, such as, for example, telescopes.

Cargo pod 3 is suspended from hull 1, mechanically separated from engine pod 4 to prevent, as effectively as possible, a transmission of vibrations of propulsion engine 5 from pod 4 to cargo pod 3 and to instruments contained in it, for example, visual monitoring instruments. Cargo pod 5 can also be stabilized in position around all three axes by corresponding devices that are known to a person skilled in the art.

Even engine pod 4 is connected with hull 1 by attachment elements. These attachment elements include a posterior central tensioning rope 41, which extends from the tail section of engine pod 4 to the tail of hull 1, a further central tensioning rope 46, which extends from the nose of engine pod 4 to the tail of hull 1, and left and right anterior and posterior tensioning ropes. Left posterior tensioning rope 42 and right, posterior tensioning rope 43 extend from the tail of engine pod 4 to the rearward end of the left, or right wing root. The left anterior tensioning rope 44 and right anterior tension rope 45 extend from the nose of engine pod 4 to the posterior end of the left or right wing root. By these tensioning ropes of engine pod 4, the advancing force generated by propeller 50 is transmitted to hull 1 of the aerial vehicle, and thereby to all other elements of the aerial vehicle.

Moreover, a number of tensioning ropes are provided bracing airfoil 2 to pod 4, which will be described in the following.

From the free ends of airfoil 2 respectively, an anterior tensioning rope 23, 24 extends from the anterior side of airfoil 2—as seen in flight direction—to the bow of engine pod 4, as well as a respective posterior tensioning rope 25, 26 from the posterior end of airfoil 2 to the bow of engine pod 4. Additionally, from the anterior side of the respective free end of airfoil 2, a second anterior tensioning rope 23′, 24′ extends to the tail of engine pod 4. A second, posterior tensioning rope 25′, 26′, extends from the posterior side of the respective free end of airfoil 2 to the tail of engine pod 4.

Furthermore, additional tensioning ropes can be provided at one or at several positions between the respective free end of airfoils 2 and the wing root adjacent to it. As an example, only anterior and posterior central tensioning ropes 27, 27′ and 28, 28′ are provided in FIG. 1, which extend from the airfoil anterior edge or from the posterior edge of the airfoil to the bow of engine pod 4.

The high-altitude aerial vehicle shown in FIG. 1 further has, at the tail of hull 1, a left pitch elevator 6 and a right pitch elevator 6′, as well as a side rudder 7.

These rudders are designed as rigid light weight elements. To stabilize the aerial vehicle around the normal axis, rigid side rudder 7 is placed onto pitch elevators 6, 6′, which is retained in position by anterior bracings 71, 72 and posterior bracings 73, 74 extending to the free ends of pitch elevators 6, 6′. The configuration of the three rudders 6, 6′, 7 is mounted rotatable around a transverse axis Y using a swivel bearing 61 provided at the tail of hull 1. A lower rudder bracing 62 is formed by a tensioning rope, that extends from the central posterior end of rudder configuration 6, 6′, 7 to the nose of engine pod 4, and an upper rudder bracing is formed by a tensioning rope 63, that extends from the upper anterior edge of rudder 7 to the upper side of hull 1.

Airfoil 2, as well as pitch elevators 6, 6′ and rudder 7 can be moved by bracings preferably attached at the free ends, which are connected with the respective rudder actuator. In the case of airfoil 2, it can be wound in the opposite direction by tightening the respective bracing 25, 25′; 26, 26′ by a rudder actuator associated with it on one side (for example, 25, 25′) and on the other side (for example, 26, 26′) it is loosened. As a result, a transverse rudder effect is achieved, which is used for the roll control of the aerial vehicle.

Pitch elevators 6, 6′ are used to control around the pitch axis and for adjusting the flight position angle, pitch elevators 6, 6′ are connected rotatable at the tail of hull 1 and can be actuated by the lower rudder bracing 62 and upper rudder bracing 63, which are respectively provided with a rudder actuator.

The components described up to now—by working together—form the flight cell of the aerial vehicle, and they can be constructed by using materials that are established and available in the market in combination with the required skills. Integrated, they result in an aerial vehicle that remains at a desired total weight of, for example, 320 kg flight weight, and delivers the required flight performance.

A high-altitude aerial vehicle designed in such a way can fly at different altitudes without losing buoyant gas due to spillage during its ascent, because the buoyant gas in the first chamber that is aiming to expand with increasing flight altitude due to the sinking exterior pressure has the ability to expand due to flexible partition wall 13. Without a change of the volume of hull 1 that is enclosed by envelope 10, the volume of first chamber 11 increases and simultaneously, the volume of the second chamber 12 decreases. To make this volume decrease of second chamber 12 possible during the ascent of the aerial vehicle, air is blown out of second chamber 12.

During the descent of the aerial vehicle from high altitude, the ambient pressure impinging on envelope 10 increases, and ambient air is blown into second chamber 12 using the fill control device in order to compensate this rise in pressure. Flexible partition wall 13 between second chamber 12 and first chamber 11 consequently brings about pressure compensation between the air in second chamber 12 and the buoyant gas in first chamber 11. In this way it is ensured that envelope 10 retains its aerodynamically efficient shape during a descent from high altitude.

Partition wall 13 is designed reflecting on its upper side 13′ and is designed infrared-absorbing on its underside 13″. For this purpose, the upper side 13′ is provided with a high-reflecting aluminum vapor deposition or aluminum coating and the underside is colored black. As a result of this design, the underside absorbs the infrared radiation emanating from the earth underneath the aerial vehicle and thereby heats the air contained in second chamber 12 during the day and in the night by more than 50° C. above the ambient temperature, so that an additional static lift is created without consuming any energy.

The envelope of hull 10 and also the envelope of the airfoil 2 are designed transparent or translucent and in the interior of hull 1 enclosed by the corresponding envelope, 1 and/or airfoil 2 photovoltaic solar generators are provided, which serve as electricity generators and supply the devices on board, instruments and also the propulsion engine with electric energy. For reasons of weight, the solar generators are constructed from thin-layer solar cells, for example, from cadmium telluride cells, which are applied to a thin film (for example, 25 μm) as carrier element.

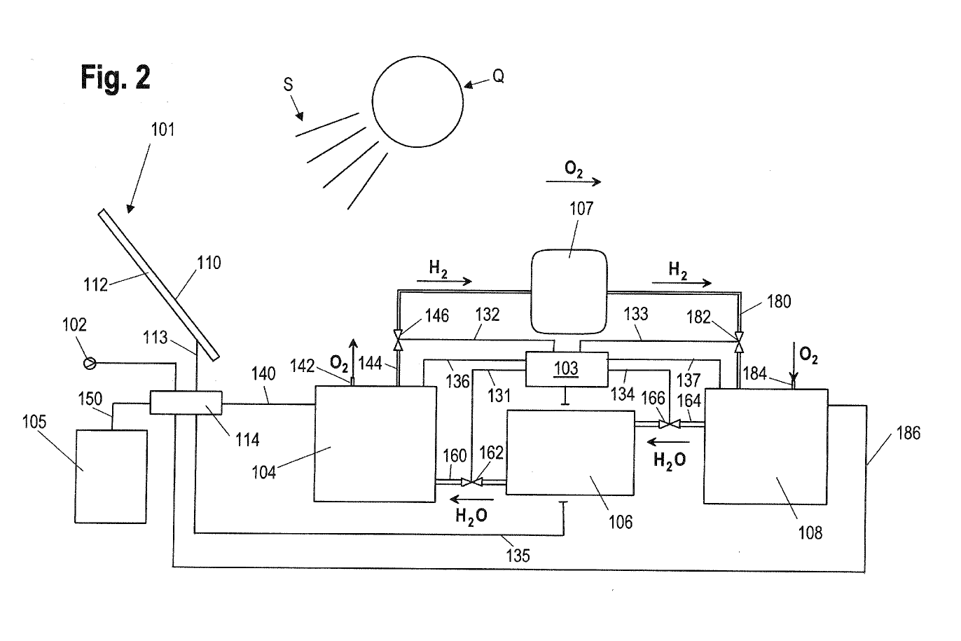

Solar generator 101 provided within hull 1 (for example in first chamber 11) is a component of the solar energy supply system 100 illustrated in FIG. 2 and as described in the following, has, for example, a diameter of 12 m and is gimbal-mounted within hull 1. A position regulation and tracking unit 15 for this gimbal-mounted solar generator 101 always aligns it optimally to the sun and guides it to track the sun. Solar generator 101 generates electric current from the incident radiation of the sun that is conveyed by (not shown) electric lines to the primary systems using electricity on board of the aerial vehicle. The systems using electricity are the instruments provided in the cargo pod, sensors and navigation systems, the electric propulsion engine 52 provided in engine pod 4 for driving the propeller 50, as well as the electric units that are also described relative to FIG. 2.

FIG. 2 shows a solar generator 101 that forms an electricity generator that is charged by solar radiation S. Solar generator 101 includes solar cells 101 on its surface directed to sun Q, which are attached to a carrier element 112. Even though the Figure only shows a carrier element 112 having solar cells 110 by way of example, solar generator 101 can, of course, have a number of carrier elements 112 that have a large surface having solar cells 101. The solar generator can also have other technologies than solar cells, with the use of which it is possible to generate electric energy from solar radiation.

The electric energy generated in solar generator 101 is fed through a first electric line 113 to a current distribution unit 102. Current distribution unit 102 is controlled by a central control unit 103 in such a way that some of the electric energy delivered via first electric line 113 is routed to a hydrogen generator 104 that is designed as a hydrogen electrolysis unit.

A further amount of the electric energy conveyed to current distribution unit 102 is delivered to energy storage 105, for example, a battery, in order to charge it in the event the electric energy storage 105 should not be sufficiently charged. The rest of the electric energy delivered to current distribution unit 102 is routed to a user connection 120, from where the electric energy provided by the photovoltaic energy supply system can be delivered to electric users.

Hydrogen generator 104 that is designed as a hydrogen electrolysis system is supplied with water from a water reservoir 106, which is formed by first chamber 11 of hull 1, via a first water line 160. In first water line 160, an electrically operable valve 162 is provided that can be controlled by control unit 103 via a first control line 130 in order to control the water inflow from water reservoir 106 to water electrolysis unit 104.

In aerial vehicles for use in lower to medium altitudes, which are to achieve greater speeds, the hydrogen gas can be stored space-saving in a streamlined, very light-weight overpressure container, preferably consisting of high-strength aramid fiber film, preferably having 1 to 2 bar overpressure, which permits taking along sufficient fuel supply when the air resistance is low.

The water introduced into water electrolysis unit 104 is split into oxygen and hydrogen by the electric energy delivered by current distribution system 102 via a second electric line 140. The oxygen is discharged into the environment by an air blowing unit 142, and the hydrogen is conveyed into a hydrogen reservoir 107 through a first hydrogen line 144.

In first hydrogen line 144, an electrically operable valve 146 is provided that can be controlled by control unit 103 via a second control line 132, to regulate the volume flow of the hydrogen transported through the first hydrogen line 144 and to prevent a back-flowing of hydrogen out of hydrogen reservoir 107 into hydrogen generator 104.

Furthermore, in FIG. 2, a fuel cell 108 is schematically shown, to which hydrogen is supplied from the hydrogen reservoir through a second hydrogen line 180. If a high power/weight ratio is required, in place of the fuel cell, a hydrogen combustion engine having a second electricity generator downstream that is preferably equipped with an exhaust turbo charger and high pressure hydrogen injection can be provided. Even in the second hydrogen line 180, an electrically operable valve 182 is provided that is controlled via a third control line 134 by control unit 103, in order to control the volume of hydrogen flowing through second hydrogen line 180.

Fuel cell 108, or the hydrogen combustion engine, furthermore has a ventilation opening 184, through which air and thus oxygen of the air can enter from the environment. In fuel cell 108 or the hydrogen combustion engine with electricity generator, electric energy is generated in known manner using hydrogen that is delivered and oxygen that enters from the air, which is conveyed via a fourth electric line 186 to electricity distribution unit 114.

The water that is created in fuel cell 108 or in the hydrogen combustion engine during the recombination of hydrogen and oxygen is introduced through a second water line 164 into water reservoir 106. In second water line 164, an electrically operable valve 166 is also provided, which can be controlled by control unit 103 via a fourth control line 134.

Control unit 103 is connected by a fifth control line 135 (shown as dotted line in FIG. 2) with current distribution unit 114, to control current distribution unit 114 and thereby the distribution of the electric energy delivered to current distribution unit 114 by first current line 113 and fourth current line 186.

Furthermore, control unit 103 is connected with hydrogen generator 104 by a sixth control line 136 to control the hydrogen generator. A seventh control line 137 connects control unit 103 with fuel cell 108, or the hydrogen combustion engine with the generator in order to control them/it.

As can be seen in FIG. 2, between hydrogen generator 104 and fuel cell 108 or the hydrogen combustion engine, a closed cycle of hydrogen (H₂) and water (H₂O) is formed including the hydrogen reservoir 106 and hydrogen reservoir 107, as is symbolized by arrows. Oxygen (O₂) is transported via an open cycle from hydrogen generator 104 to fuel cell 108, or the hydrogen combustion engine by the atmosphere, as is symbolically illustrated by the respectively indicated arrows.

This photovoltaic energy supply system provided in the high-altitude aerial vehicle according to the invention is thus only energized from the outside by solar radiation S, whereby some of the obtained electric energy is used to load buffer storage (energy storage 105 and hydrogen reservoir 107), from which the stored energy can then be retrieved and can be delivered to the users as electric energy, when top loads require such or when no, or insufficient solar radiation is available.

The design of the aerial vehicle according to the invention as a very light-weight non-rigid aerial vehicle hull inflated with hydrogen as buoyant gas of, for example, 36,000 m³ in volume having a total weight of 320 kg, combined with a very light-weight large airfoil (wing surface, for example 4,000 m²) with large elongation and very low wing loading, delivers approximately 50% to 60% of the total lift on account of the hydrogen as static lift, and the rest as dynamic lift generated by the airfoil. This dynamic lift is generated at a speed (for example, 10 m/sec), which is required when ascending into the stratosphere to overcome the high-altitude winds prevailing there in order to be able to maintain a stationary position above the earth. In this configuration, the smallest possible propulsion energy is required for generating overall lift.

The design of the wing in a manner of construction that is similar to a sliding parachute having bracing and with additional tautly blown up stabilization hoses in wingspan direction prevents a folding up of the wing in the event of turbulence. For the ascent, the aerial vehicle according to the invention can be towed in a protected environment, for example, in a protective casing, to high altitude and can then be filled with hydrogen gas there in calm air, inflated into its operating condition and taken into operation. This approach for starting the aerial vehicle according to the invention prevents damage to the light-weight, thin envelope of the hull and the airfoils due to turbulence, which can affect it at low altitude during the ascent of the aerial vehicle.

The high-altitude aerial vehicle according to the invention has the capability of changing its height as often as desired within the stratosphere, without having to thereby release buoyant gas or jettison ballast. This is achieved by the two-chamber principle with the slack partitioning membrane between the two chambers that separates the upper chamber inflated with hydrogen from the lower chamber that can be inflated with air. The second lower chamber is always maintained at a slight overpressure by blowing air into it with a blower, so that envelope 10 of hull 1 remains non-rigidly tensed at all times and thus retains its shape. Preferably, hot air is blown into the second chamber. This hot air is continually heated by the waste heat of the solar generator system, as well as the propulsion system, which can take place in an air cycle, in which air from the second chamber is conveyed through one or more heat exchangers, heats up there and is then again blown into the second chamber. This hot air then ensures additional lifting power.

It is also advantageous to attach the aerial vehicle propulsion engine 5 to engine pod 4 that is suspended under hull 1, whereby the distance between hull 1 and engine pod 4 is selected in such a way that it is larger than half of the diameter of propeller 50. At a propeller diameter of 15 m, the distance between the underside of hull 1 and the axis of rotation of the propeller extending in the center of the engine pod is at least 20 m. This ensures that propeller turbulence created by the propeller can never hit and damage envelope 10 of hull 1.

This high-altitude aerial vehicle according to the invention can thus remain—nearly without limit—at an altitude between 30 km and 38 km, for example, and can occupy a stationary position above the earth at that location. Therefore, the high-altitude aerial vehicle according to the invention is particularly suited as an observation platform or communication platform. This nearly unlimited period of use is achieved by utilizing solar energy and the recombination of hydrogen by using solar energy.

Should, over the course of time, a loss of hydrogen, for example, due to leakages, these can be compensated thereby, that the aerial vehicle—at times of low turbulence—descends to low flight altitudes below 20 km, for example, where the atmospheric humidity is high enough, so that water can be obtained from the moist air by using suitable devices. In this way, the water supply in hydrogen reservoir 107 can be replenished, so that the aerial vehicle can remain in the air for an almost unlimited period of time.

Thus, in the aerial vehicle according to the invention, during the day, propulsion engine 52 for propeller 50 is driven directly by solar generator 101, and the excess energy is used for splitting water from water reservoir 106 into water and oxygen in hydrogen generator 104. The generated hydrogen is conveyed into first chamber 11 during the day and stored there and thereby supports the filling with hydrogen when generating lift. During the night, hydrogen is removed from first chamber 11 and supplied to fuel cell 108, whereby electricity is generated that supplies propulsion engine 52 of propeller 50 and the remaining users of the aerial vehicle with electric energy. Thereby, the water is returned into water reservoir 106. As a result, a closed cycle is established for the hydrogen, which can be maintained nearly unlimited in the event no leakages from the water reservoir can be replenished.

The thus generated electric energy also drives the rudder actuators, which move the aileron for the roll control and the pitch elevator for pitch control in the manner described.

The aerial vehicle is precisely controlled by a control that combines a differential GPS system and an inertial navigation system and a stellar attitude reference system. In the stellar attitude reference system, visual direction-finding of stars is automatically performed and the result is compared with a digital celestial chart on board. Thereby, the measurement is performed at a precision of approximately 25 micro radians RMS. High precision of this type is made possible by the high flight altitude in the stratosphere, in which the view of the stars is almost unimpeded by atmospheric disturbances. The thus measured position by a star sensor and the measured position angle are summarized in a Kalman filter into a precise set of navigation data, which can be used by the control of the aerial vehicle and the sensors for regulating the position regulation of solar generator 101 and/or cargo pod 3.

By adding the stellar attitude reference system, the measurement of direction by the sensors can become more precise by a factor of ten compared to a GPS inertial navigation system by itself.

Reference numbers in the claims, the description and the drawings are only for the purpose of a better understanding of the invention and are not intended to limit the scope of protection.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE NUMBERS

The following designate:
1 Hull
2 Airfoil
3 Cargo pod
4 Engine pod
5 Propulsion system
6 Left pitch elevator
6′ Right pitch elevator
7 Rudder
10 Envelope
11 First chamber
12 Second chamber
13 Flexible partition wall
13′ Upper side of partition wall
13″ Underside of partition wall
14 Fill control unit/device
15 Position control and tracking device
20 Envelope
21 First, anterior hose
22 Second, posterior hose
23 Anterior tensioning rope
23′ Second, anterior tensioning rope
24 Anterior tensioning rope
24′ Second, anterior tensioning rope
25 Posterior tensioning rope
25′ Second, posterior tensioning rope
26 Posterior tensioning rope
26′ Second, posterior tensioning rope
27 Anterior central tensioning rope
27′ Anterior central tensioning rope
28 Posterior central tensioning rope
28′ Posterior central tensioning rope
30 Envelope
31 Anterior tensioning rope
32 Tensioning rope
33 Left, anterior tensioning rope
33′ Left, posterior tensioning rope
34 Right, anterior tensioning rope
34′ Right, posterior tensioning rope
40 Envelope
41 Central, posterior tensioning rope
42 Left, posterior tensioning rope
43 Right, posterior tensioning rope
44 Left, anterior tensioning rope
45 Right, anterior tensioning rope
50 Propeller
52 Propulsion engine
53 Power transmission tool
61 Swivel bearing
62 Lower rudder bracing
63 Upper rudder bracing
67 Upper rudder bracing
71 Anterior bracing
72 Anterior bracing
73 Posterior bracing
74 Posterior bracing
100 Energy supply unit/system
101 Solar generator
102 User connection
103 Control unit
104 Hydrogen generator
105 Electric energy storage
106 Water reservoir
107 Hydrogen reservoir
108 Fuel cell
110 Solar cells
112 Carrier/attachment element
113 First current line
114 Current distribution unit
120 Electric user connection
131 First control line
132 Second control line
133 Third control line
134 Fourth control line
135 Fifth control line
136 Sixth control line
137 Seventh control line
140 Second electric line
142 Blow-off device
144 First hydrogen line
146 Electrically operable valve
150 Third current line
160 First water line
162 Electrically operable valve
164 Second water line
166 Electrically operable valve
180 Second hydrogen line
182 Electrically operable valve
184 Ventilation opening
186 Fourth current line
Q Sun
S Radiation

What is claimed is:

1. A high-altitude aerial vehicle configured as a non-rigid aerial vehicle, comprises:
a hull having an envelope inflated at least in part with a buoyant gas other than air and which is lighter than air, wherein the buoyant gas is hydrogen,
wherein the hull has at least with a first chamber for the buoyant gas,
wherein the hull has at least one second chamber, which can be inflated with air,
wherein a flexible partition wall is arranged between the first chamber and the second chamber and is formed by a flexible membrane, and
wherein a controller or regulator is configured to inflate the second chamber with hot air depending on the flight altitude in such a way that the envelope of the hull is always tautly inflated.

2. The high-altitude aerial vehicle as recited in claim 1, wherein the first chamber is arranged in an upper part of hull and the second chamber is arranged in a lower part of the hull.

3. The high-altitude aerial vehicle as recited in claim 1, wherein the partition wall is reflecting on its upper side.

4. The high-altitude aerial vehicle as recited in claim 1, wherein the partition wall is infrared-absorbent on its underside.

5. The high-altitude aerial vehicle according to claim 1, wherein a fill control device is provided for the second chamber that has at least one blow-off valve configured to provide a controlled release of air is possible from the second chamber, and wherein the fill control device has at least one ventilation blower configured so that air from the environment can be pumped into the second chamber.

6. The high-altitude aerial vehicle as recited in claim 5, wherein the fill control device has a solar heat exchanger configured to heat the air flowing into the second chamber using impinging solar radiation.

7. The high-altitude aerial vehicle as recited in claim 6, wherein the fill control device is configured in such a way that air contained in an interior of the second chamber can be circulated by the solar heat exchanger in a flowing stream.

8. The high-altitude aerial vehicle according to claim 1, wherein at least one pod is arranged underneath the hull, the at least one pod houses cargo and is connected with the hull by attachment elements formed by tensioning ropes.

9. The high-altitude aerial vehicle according to claim 1, wherein the hull includes at least with one airfoil configured to generate aerodynamic lift.

10. The high-altitude aerial vehicle as recited in claim 9, wherein the airfoil has an aerodynamically shaped envelope in cross-section consisting of a biaxially oriented polyester thin film, the airfoil has at least one hose in a wingspan direction that is inflatable with pressurized gas, the at least one hose forming a reinforcement of airfoil in inflated condition in the wingspan direction, and free ends of the airfoil are tensed against the hull or against a pod provided underneath the hull having bracing units including tensioning ropes.

11. The high-altitude aerial vehicle according to claim 1, further comprising:
an electrically operated propulsion engine with at least one propeller, the propulsion engine is located in an engine pod arranged underneath hull.

12. The high-altitude aerial vehicle as recited in claim 11, further comprising:
a photovoltaic energy supply unit configured to generate propulsion energy, the photovoltaic energy supply unit comprising
at least one photovoltaic solar generator configured to transform impinging solar radiation into electric energy;
at least one hydrogen generator configured to generate hydrogen from water;
at least one water reservoir connected with the hydrogen generator by a first water line;
at least one hydrogen reservoir formed by the first chamber that is connected by a first hydrogen line with the hydrogen generator;
at least one fuel cell connected by a second hydrogen line with the hydrogen reservoir, and which is connected by a second water line with the water reservoir, and
a control unit electrically connected with the solar generator, the hydrogen generator and the fuel cell.

13. The high-altitude aerial vehicle as recited in claim 12, wherein the hydrogen generator has a water electrolysis device.

14. The high-altitude aerial vehicle as recited in claim 12, wherein the solar generator has at least one carrier element having solar cells, which is formed by a panel.

15. The high-altitude aerial vehicle as recited in claim 12, wherein the solar generator has at least one carrier element having solar cells, which is formed by a biaxially oriented polyester thin film.

16. The high-altitude aerial vehicle as recited in claim 14, wherein the solar cells are thin-layer cadmium telluride cells.

17. The high-altitude aerial vehicle as recited claim 12, further comprising:
an additional electric energy storage in the form of a battery.

18. The high-altitude aerial vehicle as recited in claim 12, wherein the control unit is configured such that
in presence of solar radiation, electric energy generated by the solar generator is fed to an electric user connection of an energy supply system, and
in an absence of solar radiation or when the electric energy generated by the solar generator is insufficient for a specified energy requirement, the fuel cell is activated in order to supply electric energy to the user connection.

19. The high-altitude aerial vehicle as recited in claim 18, wherein the control unit is configured such that
in the presence of solar radiation, a part of the electric energy generated by solar generator is delivered to the hydrogen generator, and
the control unit delivers water to the hydrogen generator from the water reservoir so that the hydrogen generator is activated to create hydrogen from the water that is supplied to it, the generated hydrogen being stored in hydrogen reservoir.

20. The high-altitude aerial vehicle as recited in claim 18, wherein a part of the electric energy generated by the solar generator or by the fuel cell is conveyed to an energy storage element in order to charge the energy storage element.

21. The high-altitude aerial vehicle as recited claim 12, wherein the solar generator is located in an interior of the envelope of the aerial vehicle that has least some transparent sections.

22. The high-altitude aerial vehicle as recited in claim 21, wherein the solar generator is gimbal-mounted and is provided with a tracking device that orients the solar generator to the sun.

23. The high-altitude aerial vehicle according to claim 1, wherein the aerial vehicle has pitch elevators attached to the hull or at least one rudder attached to the hull.
